(19) United States
(12) Patent Application Publication
(10) Pub. No.: US 2002/0191160 A1
(43) Pub. Date: Dec. 19, 2002

(54) Display apparatus with adjustable imaging area

(76) Inventor: Fu-Ming Chuang, Hsin-Chu Hsien (TW)

Correspondence Address: TROP PRUNER & HU, PC, 8554 KATY FREEWAY, SUITE 100, HOUSTON, TX, 77024, US

(21) Appl. No.: 09/880,869

(22) Filed: Jun. 13, 2001

(51) Int. Cl. G03B 21/20

(52) U.S. Cl. 353/85

(57) ABSTRACT

A display apparatus includes a light source, a light integrator, a positive lens unit, and a liquid crystal display panel that are arranged in sequence and that are aligned along an optical axis. Light from the light integrator passes through the positive lens unit before reaching the display panel. The positive lens unit includes at least first and second lens components, each of which is formed from at least one lens member. The first lens component is movable relative to the light integrator along the optical axis, and the second lens component is movable relative to the first lens component along the optical axis for forming an image with a desired focusing, brightness and magnification factor on the display panel.

### BACKGROUND OF THE INVENTION

1. Field of the Invention

The invention relates to a display apparatus, more particularly to one having an adjustable imaging area to suit the size of the liquid crystal display panel that is in use.

2. Description of the Related Art

The image on a conventional display is formed from point-light pixels that consist of primary color components, such as red, green and blue color components. In order to enhance the quality of images shown on a display, light from a light source is processed before being projected by a projection lens on the display.

Referring to FIG. 1, a conventional optical display system 1 is shown to comprise a light source 11, a light integrator 12, first and second condenser lenses 13, 14 and a liquid crystal display panel 15 that are arranged in sequence and that are aligned along an optical axis. The light integrator 12 is disposed in a light-radiating path of the light source 11, and allows evenly distributed light to pass therethrough. The light integrator 12 can be a glass rod integrator, or a hollow pipe integrator having an inner wall surface that is plated with a reflective film. The first condenser lens 13 is disposed in an output optical path of the light integrator 12. The second condenser lens 14 receives condensed light from the first condenser lens 13, and projects condensed light on the liquid crystal display panel 15 to form an image on the latter.

In the conventional optical display system 1, the first and second condenser lenses 13, 14 are disposed at fixed locations between the light integrator 12 and the liquid crystal display panel 15 so as to form an image with a desired focusing, brightness and magnification factor in accordance with the size of the liquid crystal display panel 15. When a differently sized liquid crystal display panel 15 is to be installed in the conventional optical display system 1, the relative positions among the relevant components inside the conventional optical display system 1 should be adjusted to ensure that a properly focused and properly sized image with a desired brightness can be formed on the liquid crystal display panel 15. Such an adjustment is not possible in the conventional optical display system 1 because the positions of the first and second condenser lenses 13, 14 are fixed.

### SUMMARY OF THE INVENTION

Therefore, the main object of the present invention is to provide a display apparatus with adjustable lens components for forming an image with a desired focusing, brightness and magnification factor to suit the size of the liquid crystal display panel that is in use.

According to the present invention, a display apparatus comprises a light source, a light integrator, a positive lens unit, and a liquid crystal display panel that are arranged in sequence and that are aligned along an optical axis. The light integrator processes light radiated by the light source, and allows evenly distributed light to pass therethrough. The positive lens unit is disposed between the light integrator and the liquid crystal display panel such that the light from the light integrator passes through the positive lens unit before reaching the liquid crystal display panel. The positive lens unit includes at least first and second lens components, each of which is formed from at least one lens member. The first lens component is movable relative to the light integrator along the optical axis, and the second lens component is movable relative to the first lens component along the optical axis for forming an image with a desired focusing, brightness and magnification factor on the liquid crystal display panel.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram of a conventional optical display system;

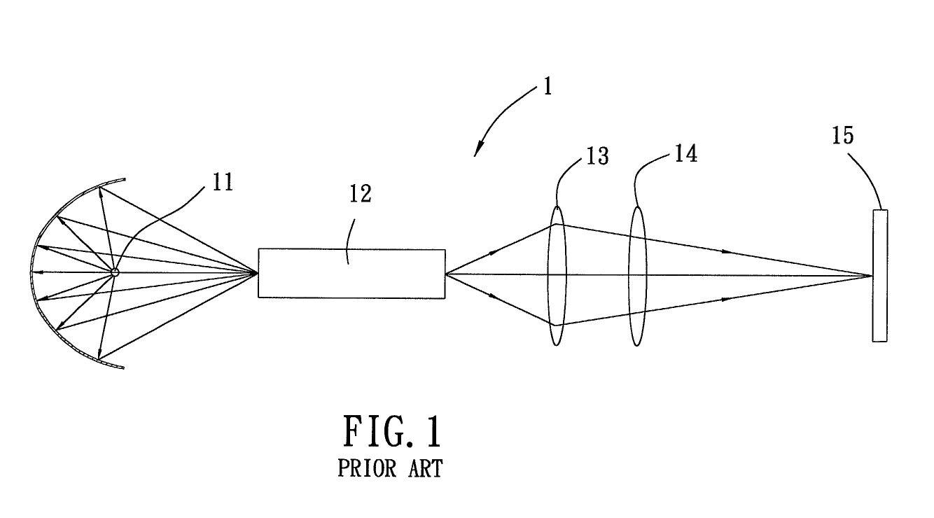

FIG. 2 is a schematic diagram illustrating the preferred embodiment of a display apparatus with an adjustable imaging area according to the present invention;

FIG. 3 illustrates how light is processed by a single lens in a conventional manner; and

FIG. 4 illustrates how light is processed by a positive lens unit of the display apparatus of the preferred embodiment.

### DETAILED DESCRIPTION OF THE PREFERRED EMBODIMENT

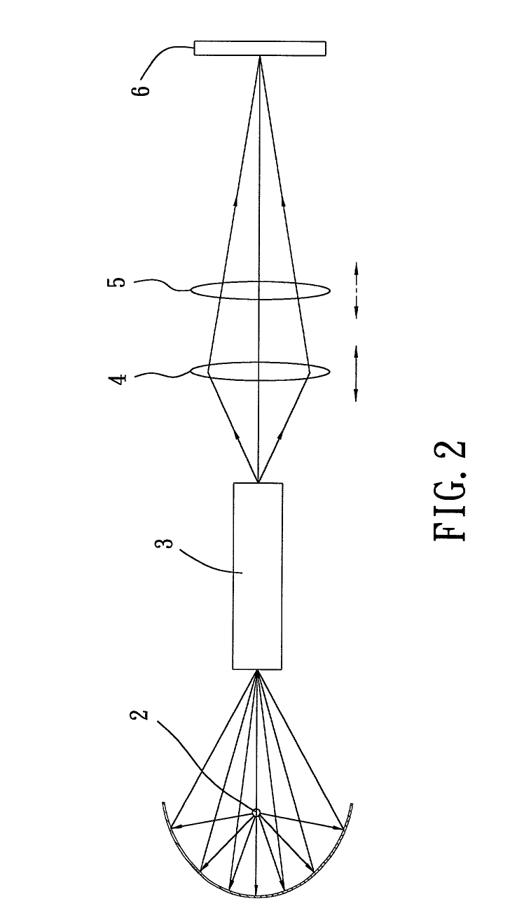

Referring to FIG. 2, the preferred embodiment of a display apparatus with an adjustable imaging area according to the present invention is shown to comprise a light source 2, a light integrator 3, a positive lens unit, and a liquid crystal display panel 6 that are arranged in sequence and that are aligned along an optical axis. The light integrator 3 is disposed in a light-radiating path of the light source 2 for processing light radiated by the light source 2, and allows evenly distributed light to pass therethrough. The light integrator 3 can be a glass rod integrator, or a hollow pipe integrator having an inner wall surface that is plated with a reflective film. The positive lens unit is disposed between the light integrator 3 and the liquid crystal display panel 6 such that the light from the light integrator 3 passes through the positive lens unit before reaching the liquid crystal display panel 6. In this embodiment, the positive lens unit includes first and second lens components 4, 5, each of which is formed from at least one lens member, which can be a concave lens member, a convex lens member or a combination of concave and convex lens members. The first lens component 4 is movable relative to the light integrator 3 along the optical axis, and the second lens component 5 is movable relative to the first lens component 4 along the optical axis for forming an image with a desired focusing, brightness and magnification factor on the display panel 6. It should be noted that, in the display apparatus of this invention, the positive lens unit can include more than two lens components that are movable along the optical axis between the light integrator 3 and the liquid crystal display panel 6.

The operation of the display apparatus of this invention will now be described in greater detail in the succeeding paragraphs.

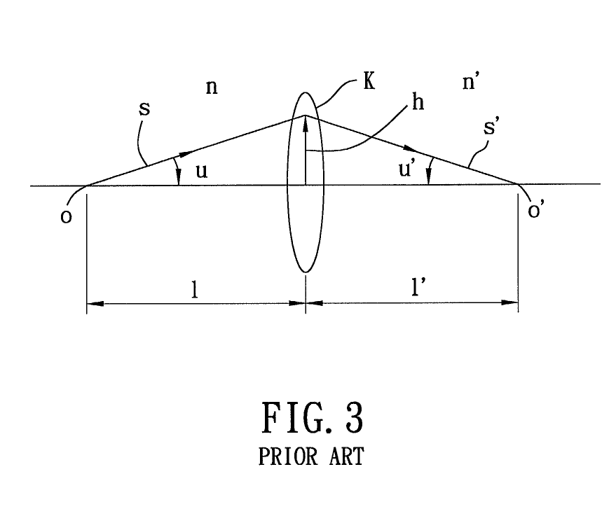

FIG. 3 illustrates how light is processed by a single lens in a conventional manner. As shown, the space to the left of a lens (K) is an object space, whereas the space to the right of the lens (K) is an image space. Light ray (s) is disposed in the object space, whereas light ray (s′) is disposed in the image space. The light rays (s, s′) form a respective incident angle (u, u′) with respect to an optical axis (o-o′). The incident angle has a positive value when the direction from the light ray to the optical axis is a counterclockwise direction, and has a negative value when otherwise.

A distance (l) is formed between an object (o) and a first main plane of the lens (K). A distance (l′) is formed between an image (o′) and a second main plane of the lens (K). When the lens (K) is very thin, the first and second main planes can be considered to overlap at the central axis of the lens (K). In the arrangement of FIG. 3, distances measured to the right of the lens (K) have positive values, while those measured to the left of the lens (K) have negative values. As such, the object distance (l) has a negative value, whereas the image distance (l′) has a positive value.

The light rays (s, s′) form a height (h) on the plane of the lens (K). The height (h) has a positive value when measured upwardly from the optical axis, and has a negative value when otherwise.

The object space and the image space have refractive indices (n, n′), respectively.

The lens (K) has a focusing power (k) and a focal length (f).

In the arrangement of FIG. 3, assuming that n=n′=1, the lens formula for the thin lens (K) is 1/l′−1/l=1/f=k. The magnification factor (M) is l′/l. As such, l=(1/M−1)f, and l′=(1−M)f. The object-image distance (T) is (−l)+l′=(2−M−1/M)f.

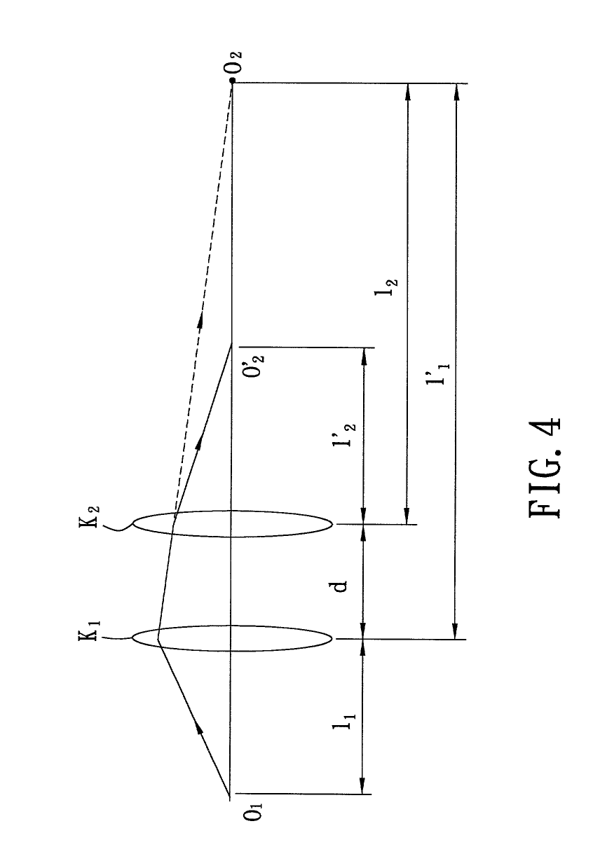

Referring again to FIG. 2, the positive lens unit is a variable focusing optical system. FIG. 4 illustrates how light is processed by the positive lens unit in the display apparatus of the present invention. As shown, each of the first and second lens components 4, 5 of the positive lens unit is represented by a respective single lens (K₁, K₂). Each of the lenses (K₁, K₂) is assumed to be very thin such that the opposing main planes thereof can be considered to overlap at the central axis of the respective lens (K₁, K₂). The lenses (K₁, K₂) have a respective magnification factor (M₁, M₂) and a respective focal length (f₁, f₂).

An object (O₁) is disposed at an output end of the light integrator 3. The image (O₂) is disposed at a receiving end of the liquid crystal display panel 6. A distance (1₁) is formed between the object (O₁) and the first lens (K₁), whereas a distance (1′₁) is formed between the first lens (K₁) and the image (O₂). A distance (1₂) is formed between the second lens (K₂) and the image (O₂), whereas a distance (1′₂) is formed between the second lens (K₂) and an imaging plane (O′₂) thereof. A distance (d) is present between the first and second lenses (K₁, K₂).

In the present embodiment, the object-image distance (T₁₂) is maintained at a predetermined value during focusing adjustment and is equal to (2−M₁−1/M₁)f₁+(2−M₂−1/M₂)f₂. l₁=(1/M₁−1)f₁, l′₁=(1−M₁)f₁, l₂=(1/M₂−1)f₂, l′₂=(1−M₂)f₂, d=l′₁−l₂.

Thus, during focusing adjustment, the first lens (K₁) is adjusted to adjust the distance (l₁). The values of M₁, M₂, l′₂ and d are then obtained with the use of the aforementioned equations. As such, without varying the object-image distance (T₁₂) between the light integrator 3 and the liquid crystal display panel 6, by moving the first lens component 4 relative to the light integrator 3 along the optical axis, and by moving the second lens component 5 relative to the first lens component 4 along the optical axis, the focusing, brightness and magnification factor of an image formed on the liquid crystal display panel 6 can be conveniently adjusted to correspond with the size of the liquid crystal display panel 6 that is in use.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A display apparatus comprising a light source, a light integrator, a positive lens unit, and a liquid crystal display panel that are arranged in sequence and that are aligned along an optical axis;
said light integrator processing light radiated by said light source and allowing evenly distributed light to pass therethrough;
said positive lens unit being disposed between said light integrator and said liquid crystal display panel such that the light from said light integrator passes through said positive lens unit before reaching said liquid crystal display panel, said positive lens unit including at least first and second lens components, each of which is formed from at least one lens member, wherein said first lens component is movable relative to said light integrator along the optical axis, and said second lens component is movable relative to said first lens component along the optical axis for forming an image with a desired focusing, brightness and magnification factor on said liquid crystal display panel.

2. The display apparatus of claim 1, wherein said light integrator is a glass rod integrator.

3. The display apparatus of claim 1, wherein said light integrator is a hollow pipe integrator having a reflective inner wall surface.
